(19) United States
(12) Patent Application Publication
(10) Pub. No.: US 2023/0289079 A1
(43) Pub. Date: Sep. 14, 2023

(54) RAPID DATA REPLICATION AND DATA STORAGE

(71) Applicant: Kyndryl, Inc., New York, NY (US)

(72) Inventors: Siddalinga A. HS, BENGALURU (IN); Ravi K. RAGHUNATHAN, BANGALORE (IN); Venkata Hari K. PANJANI, BANGALORE (IN); Raja KANDE, BANGALORE (IN); Manu SHIVANNA, BANGALORE (IN)

(21) Appl. No.: 17/691,834

(22) Filed: Mar. 10, 2022

(51) Int. Cl. G06F 3/06

(52) U.S. Cl. CPC G06F 3/064; G06F 3/0659; G06F 3/0619; G06F 3/0673

(57) ABSTRACT

Aspects of the present disclosure relate generally to data storage and data replication. For example, a computer-implemented method includes creating, by a computing device, a mapping that associates a plurality of block identifiers with a plurality of binary combinations of data for a block size; generating from the mapping that associates the plurality of block identifiers with the plurality of binary combinations of data for the block size, by the computing device, a list of block identifiers representing a list of data blocks in a storage; sending, by the computing device, the list of block identifiers to a backup storage to replicate the list of data blocks in the storage; and storing on a computer readable storage media the mapping that associates the plurality of block identifiers with the plurality of binary combinations of data for the block size and the list of block identifiers in the storage.

### BACKGROUND

Aspects of the present invention relate generally to data storage and, more particularly, to data replication.

Millions of blocks of data are stored daily in the cloud using block storage. Block storage breaks up data files into data blocks and then stores those data blocks separately in cloud-based storage environments. In doing so, the data blocks can be distributed across different storage systems and stored wherever it is most efficient.

Block storage is often used for workloads requiring network-based and low-latency storage operations. Examples include databases, virtual machines, containers, Hadoop nodes and web servers. Typically, disaster recovery for these workloads involves replicating data from primary storage to backup storage. Terabytes of data may be replicated across regions and consume high network bandwidth.

### SUMMARY

In a first aspect of the invention, there is a computer-implemented method including: creating, by a computing device, a mapping that associates a plurality of block identifiers with a plurality of binary combinations of data for a block size; generating from the mapping that associates the plurality of block identifiers with the plurality of binary combinations of data for the block size, by the computing device, a list of block identifiers representing a list of data blocks in a storage; sending, by the computing device, the list of block identifiers to a backup storage in a cloud-based storage environment to replicate the list of data blocks in the storage; and storing on a computer readable storage media the mapping that associates the plurality of block identifiers with the plurality of binary combinations of data for the block size and the list of block identifiers in the storage.

In another aspect of the invention, there is a computer program product including one or more computer readable storage media having program instructions collectively stored on the one or more computer readable storage media. The program instructions are executable to: receive, by a computing device, a block identifier for replication of a data block; identify, by the computing device, the block identifier in a mapping that associates a plurality of block identifiers with a plurality of binary combinations of data for a block size; and store on a computer readable storage media, by the computing device, the block identifier in a list of block identifiers for replication of a list of data blocks.

In another aspect of the invention, there is a system including a processor, a computer readable memory, one or more computer readable storage media, and program instructions collectively stored on the one or more computer readable storage media, the program instructions executable to: create, by the processor, a mapping that associates a plurality of block identifiers with a plurality of binary combinations of data for a block size; generate from the mapping that associates the plurality of block identifiers with the plurality of binary combinations of data for the block size, by the processor, a list of block identifiers representing a list of data blocks in a storage; send, by the processor, the list of block identifiers to a backup storage in a cloud-based storage environment to replicate the list of data blocks in the storage; and store on a computer readable storage media the mapping that associates the plurality of block identifiers with the plurality of binary combinations of data for the block size and the list of block identifiers in the storage.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment in accordance with aspects of the invention.

FIG. 3 depicts abstraction model layers in accordance with aspects of the invention.

FIG. 4 shows a block diagram of an exemplary environment in accordance with aspects of the invention.

FIG. 5 depicts an exemplary data structure in accordance with aspects of the invention.

FIG. 6 depicts an exemplary data structure in accordance with aspects of the invention.

FIG. 7 shows a flowchart of an exemplary method in accordance with aspects of the invention.

FIG. 8 shows a flowchart of an exemplary method in accordance with aspects of the invention.

FIG. 9 shows a flowchart of an exemplary method in accordance with aspects of the invention.

FIG. 10 depicts an exemplary circuit diagram in accordance with aspects of the invention.

FIG. 11 shows a flowchart of an exemplary method in accordance with aspects of the invention.

FIG. 12 shows a flowchart of an exemplary method in accordance with aspects of the invention.

FIG. 13 shows a block diagram of an exemplary environment in accordance with aspects of the invention.

FIG. 14 shows a flowchart of an exemplary method in accordance with aspects of the invention.

FIG. 15 depicts an exemplary architecture in an exemplary cloud computing environment in accordance with aspects of the invention.

### DETAILED DESCRIPTION

Aspects of the present invention relate generally to data storage and, more particularly, to data replication. More specifically, aspects of the invention relate to methods and systems for providing rapid data replication and data storage between a machine and the cloud using a permuto-combination method and universally unique identifiers (UUIDs) for auto-generating data based on a given block number using a mapping technique, e.g., for 512 bytes of block size. For example, the methods, systems and program products described herein restore a list of data blocks in primary storage by retrieving the list of block identifiers from backup storage and automatically generating the data blocks from a block mapping table for each of the block identifiers.

According to aspects of the invention, the methods, systems and program products described herein create a block mapping table that associates block identifiers with binary combinations of data in order to replicate a list of data blocks in primary storage. In embodiments, the methods, systems and program products described herein receive a list of data blocks in primary storage, generate a list of block identifiers from the list of data block using the block mapping table, and send the list of block identifiers to a backup storage for replication of the list of data blocks. Each block identifier generated for a data block is stored in the block mapping table with the block data. In this manner, implementations of the invention may replicate a list of data blocks by sending the block identifiers and may automatically generate the data blocks from the block mapping table for each of the block identifiers. Using the block mapping table, it is possible to update block identifiers for replicated data blocks that are updated and send the updated block identifiers to backup storage to replace the block identifiers for those replicated data blocks.

Aspects of the present invention are directed to improvements in computer-related technology. In embodiments, the system including a processor, a computer readable memory, one or more computer readable storage media, and program instructions collectively stored on the one or more computer readable storage media may create a mapping that associates a plurality of block identifiers with a plurality of binary combinations of data for a block size; generate from the mapping that associates the plurality of block identifiers with the plurality of binary combinations of data for the block size a list of block identifiers representing a list of data blocks in a storage; send the list of block identifiers to a backup storage to replicate the list of data blocks in the storage; and store on a computer readable storage media the mapping that associates the plurality of block identifiers with the plurality of binary combinations of data for the block size and the list of block identifiers in the storage. Thus, implementations of the invention may replicate a list of data blocks by sending the block identifiers and may automatically generate the data blocks from the block mapping table for each of the block identifiers. These are specific improvements in the way computers may operate to replicate and store data.

Additional aspects of implementations of the invention make further non-abstract improvements to computer technology. For instance, a computer program product including one or more computer readable storage media having program instructions collectively stored on the one or more computer readable storage media may receive, by a computing device, a block identifier for replication of a data block, identify, by the computing device, the block identifier in a mapping that associates a plurality of block identifiers with a plurality of binary combinations of data for a block size, and store on a computer readable storage media, by the computing device, the block identifier in a list of block identifiers for replication of a list of data blocks, among other substantial, non-trivial technological improvements. Implementations of the invention describe additional elements that are specific improvements in the way computers may operate and these additional elements provide non-abstract improvements to computer functionality and capabilities.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

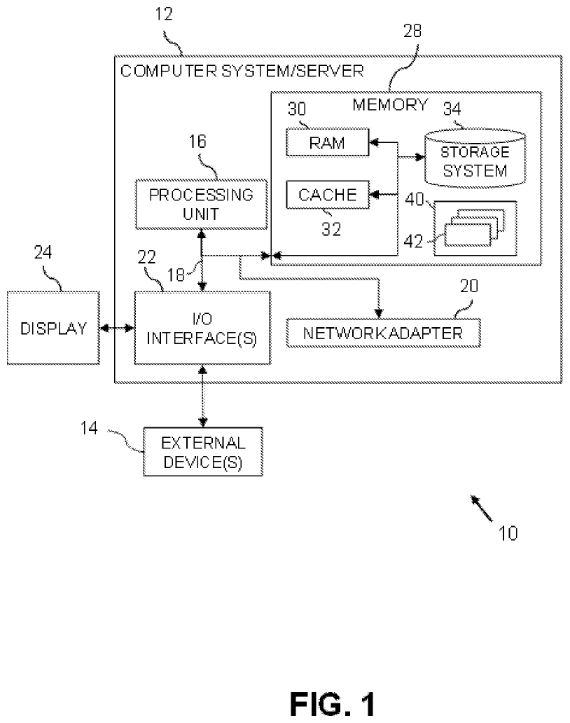

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

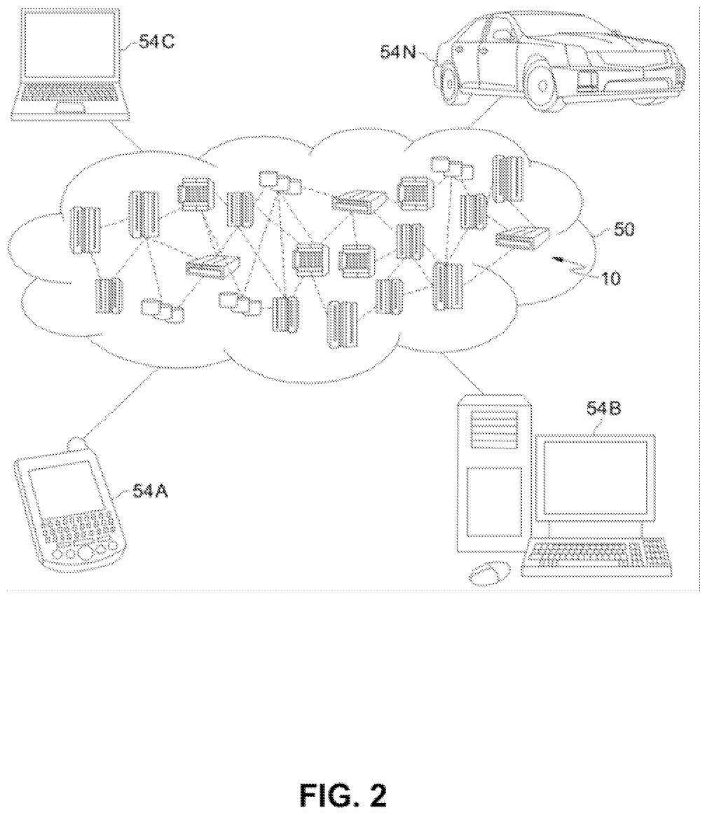

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

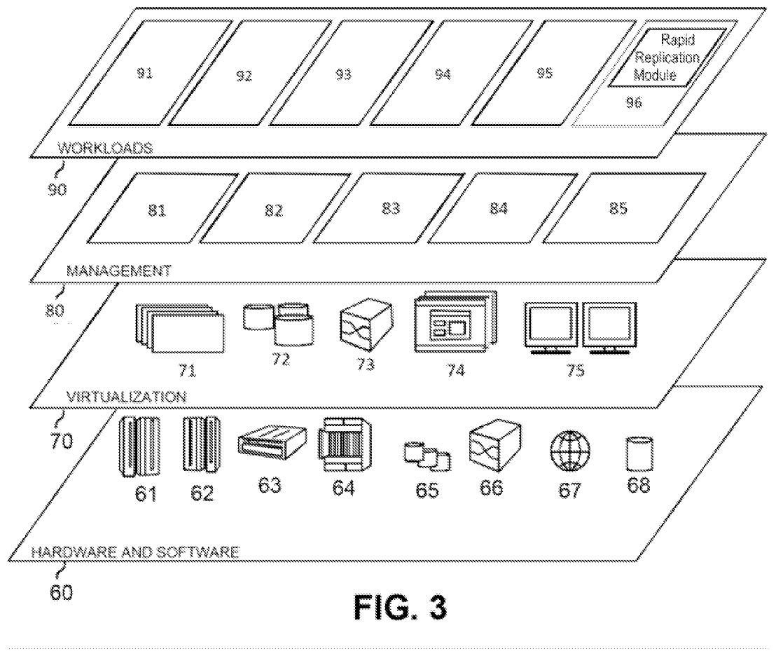

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and rapid data replication processing 96.

Implementations of the invention may include a computer system/server 12 of FIG. 1 in which one or more of the program modules 42 are configured to perform (or cause the computer system/server 12 to perform) one of more functions of the rapid data replication processing 96 of FIG. 3. For example, the one or more of the program modules 42 may be configured to: create a block mapping table that associates block identifiers with binary combinations of data in order to replicate a list of data blocks in primary storage, receive a list of data blocks in primary storage, generate a list of block identifiers from the list of data block using the block mapping table, and send the list of block identifiers to a backup storage for replication of the list of data blocks.

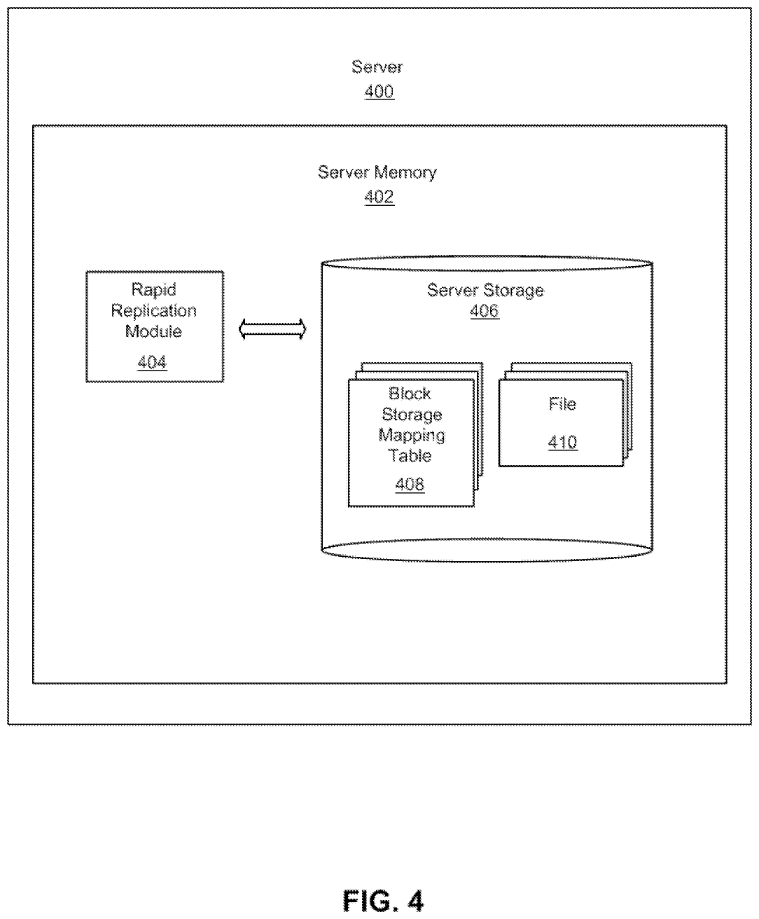

FIG. 4 shows a block diagram of an exemplary environment in accordance with aspects of the invention. In embodiments, the environment includes a server 400, which may be a computer system such as computer system 12 described with respect to FIG. 1, and a server memory 402 such as memory 28 described with respect to FIG. 1. In general, the server 400 provides services required for data storage, data replication, and data recovery. The server 400 includes, in memory 402, a rapid replication module 404 having functionality to create a block mapping table that associates block identifiers with binary combinations of data, receives a list of data blocks in primary storage, generates a list of block identifiers from the list of data block using the block mapping table, and sends the list of block identifiers to a backup storage for replication of the list of data blocks. The rapid replication module 404 may also have functionality to update block identifiers for replicated data blocks that are updated and send the updated block identifiers to backup storage to replace the block identifiers for those replicated data blocks. The rapid replication module 404 may also have functionality to restore a list of data blocks in primary storage by retrieving the list of block identifiers from backup storage and automatically generating the data blocks from the block mapping table for each of the block identifiers.

In embodiments, the rapid replication module 404 may comprise one or more program modules such as program modules 42 described with respect to FIG. 1. The server 400 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In accordance with aspects of the invention, the server 400 also includes, in memory 402, server storage 406 which may be computer storage such as system storage 34 described with respect to FIG. 1. In embodiments, server storage 406 stores information for mapping block identifiers with block data in a block storage mapping table 408, and stores files 410 that may each be divided into evenly sized data blocks for block storage. For example, a file 410 may be divided into fixed-sized data blocks of 512 bytes. In this case, the block storage mapping table 408 may store the association of block identifiers with data blocks representing binary combinations of 4096 bits. Those skilled in the art should appreciate that other fixed-sized data block may be used in embodiments such as 128 byte data blocks, 256 byte data blocks and so forth.

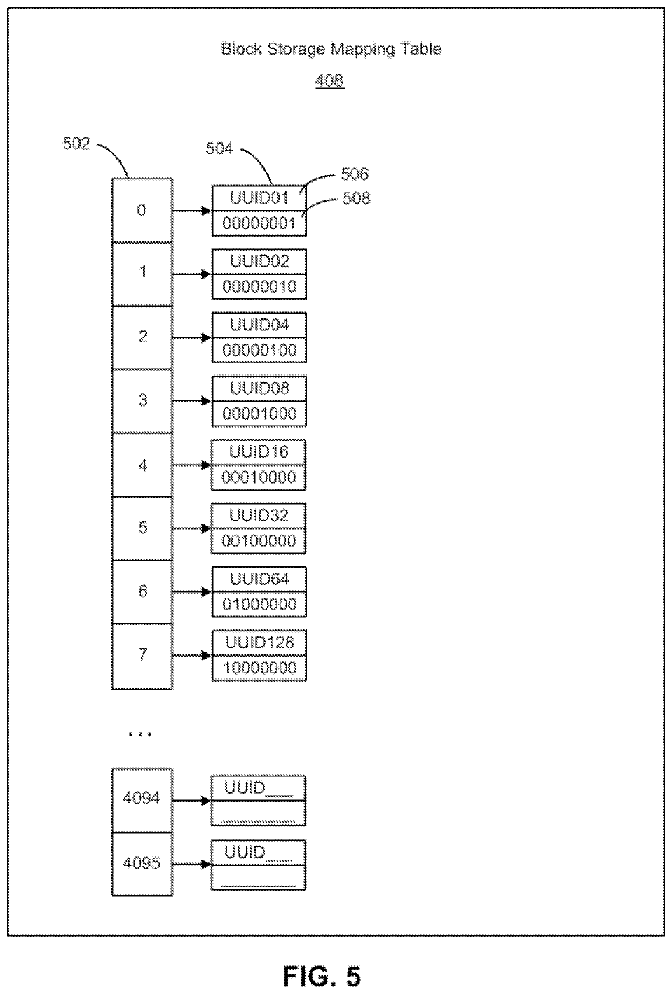

FIG. 5 depicts an exemplary data structure for creating a block storage mapping table for fixed-sized data blocks of 512 bytes. For example, FIG. 5 illustrates a block storage mapping table 408 represented as a table implemented as an associative array of elements 502 that is indexed by exponents of powers of two into buckets of linked list nodes, such as linked list node 504, storing in ascending order the association of block identifiers, such as block identifier 506, and block data, such as block data 508, for the binary combinations of 512 bytes from 2ⁿ to 2ⁿ⁺¹−1 for a given exponent of a power of two. As shown in FIG. 5, the associative array of elements 502 stores integers from 0 to 4095 that represent 2ⁿ buckets where n is the number of bits in a fixed-sized data block of 512 bytes. Each of the linked list nodes associate a block identifier with block data belonging to that bucket for a given exponent of a power of two.

The first linked list node for each bucket for a given exponent of a power of two has the binary value of base two to that exponent of the power of two for indexing that bucket assigned to the block data for that first linked list node. For example, linked list node 504 is shown with block data 508 assigned the value of 00000001, the lower order 8 bits of 512 bytes of the binary value of 2°. FIG. 5 only shows the lower order 8 bit values of a 512-byte data block for brevity of illustration. The first linked list node for each bucket for a given exponent of a power of two has a block identifier assigned a value of a universally unique identifier (UUID) appended with the decimal value of the exponent of the power of two for indexing that bucket. For example, linked list node 504 is shown with block identifier 506 assigned the value UUID01. In this manner, the first linked list node may be initialized for each array element in an embodiment as illustrated in FIG. 5.

Those skilled in the art should appreciate that other values may be assigned as unique block identifiers in an embodiment. For instance, an initial UUID with a date and time stamp can be generated and assigned the lowest binary value of 00000000 in an embodiment. This UUID can be incremented by a microsecond for each subsequent UUID that is assigned to the next sequentially ordered block data of the binary combinations of 512 bytes. For example, the initial UUID with the date and time stamp can be incremented by 1 microsecond and assigned as the UUID to the initial linked list node 506 that is assigned the value of 00000001, the lower order 8 bits of 512 bytes of the binary value of 2⁰. In this manner, each UUID may be accordingly assigned so that block identifiers result in an assignment in ascending order by date and time stamp incremented by 1 microsecond in one-to-one correspondence to each block data of the binary combinations of 512 bytes in ascending order by binary value. An example of such an assignment may be a UUID of 6 Jan. 2022 8.46.31 for block data 00000000, UUID of 6 Jan. 2022 8.46.32 for block data 00000001, and UUID of 6 Jan. 2022 8.46.33 for block data 00000010, where the time stamp of 8.46.31 is incremented by a microsecond to 8.46.32 and again to 8.46.33 for each subsequent UUID that is assigned to the next sequentially ordered block data of the binary combinations of 512 bytes.

Additional block data may be added to the binary storage mapping table 408 initialized as shown in FIG. 5 by inserting linked list nodes for any other binary combination of 512-byte data blocks and assigning the corresponding block identifier that maintains the one-to-one correspondence from lowest value to highest value of block identifiers assigned with values arranged in ascending sequential order to binary block data values arranged in ascending sequential order.

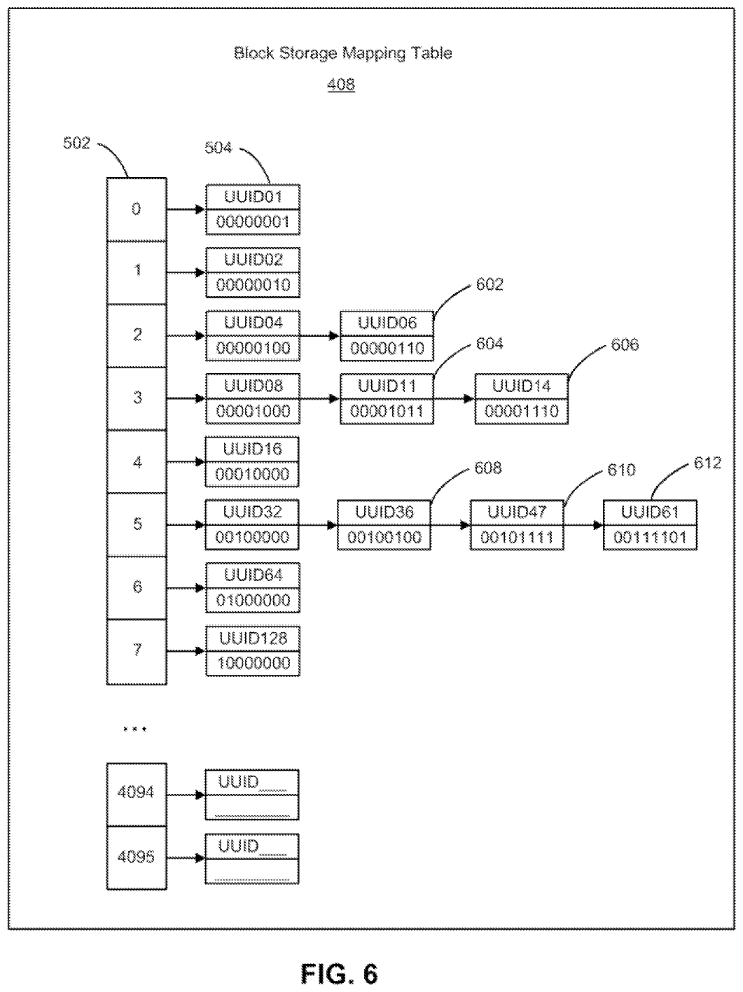

FIG. 6 depicts a list of data blocks added to the exemplary data structure shown in FIG. 5 for creating a block storage mapping table for fixed-sized data blocks of 512 bytes. For instance, consider the following list of 512-byte data blocks with these lower order 8 bit values: 00001110, 00111101, 00001011, 00100100, 00101111, and 00000110. The first data block in the list, 00001110, can be inserted in the block storage mapping table 408 by calculating the exponent for the power of two that has the closest lower binary value (i.e. 8) than the binary value of the data block (i.e. 14), which is the exponent 3. A linked list node, such as node 606 shown in FIG. 6, can be inserted with the block data assigned the binary value of 00001110 in the linked list of nodes by indexing the array element with the value of 3, traversing the linked list of nodes in that bucket of the array element, and inserting that node in the linked list of nodes in the order of ascending binary value. The block identifier for node 606 can be assigned to that node by incrementing the block identifier value of the first node in the linked list of nodes in that bucket of the array element by the difference of the values of the block data of the inserted node (i.e. 14) and the first node (i.e. 8). Accordingly, node 606 is assigned the block identifier of UUID14 as shown. In this same manner, nodes 612, 604, 608, 610, and 602 can be, in turn, inserted into the block storage mapping table 408 with their respective 512-byte block data values with the lower order 8 bits of 00111101, 00001011, 00100100, 00101111, and 00000110. Accordingly, a block storage mapping table may be created that associates block identifiers with binary combinations of data and can generates block identifiers for data blocks.

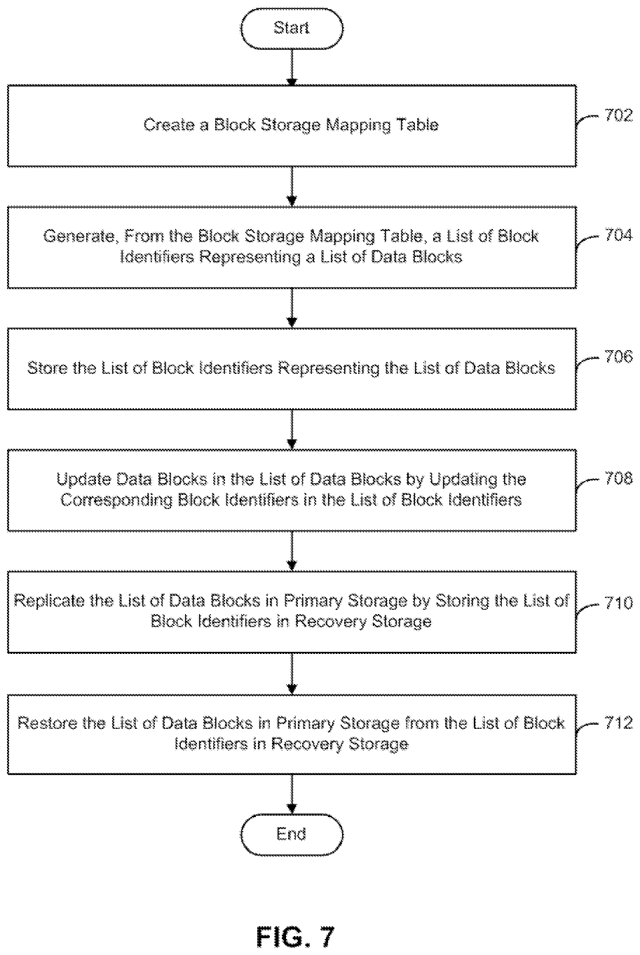

FIGS. 7-9, 11-12, and 14-15 show flowcharts and/or block diagrams that illustrate the architecture, functionality, and operation of possible implementations of systems, methods, and computer program products according to various embodiments of the present invention. As noted above, each block may represent a module, segment, or portion of instructions, which comprises one or more executable instructions for implementing the specified logical function(s). The functions noted in the blocks may occur out of the order, two blocks shown in succession may, in fact, be accomplished as one step, executed concurrently, substantially concurrently, in a partially or wholly temporally overlapping manner, or the blocks may sometimes be executed in the reverse order, depending upon the functionality involved. And some blocks shown may be executed and other blocks not executed, depending upon the functionality involved.

FIG. 7 shows a flowchart of an exemplary method in accordance with aspects of the present invention. Steps of the method may be carried out in the environment of FIG. 4 and are described with reference to elements depicted in FIG. 4.

At step 702, the system creates a block storage mapping table. The block storage mapping table associates block identifiers with binary combinations of data and can generate block identifiers for data blocks. In an implementation with fixed-sized data blocks of 512 bytes, the block storage mapping table may store the association of block identifiers with data blocks representing binary combinations of 4096 bits. In an embodiment, the rapid replication module 404 as shown in FIG. 4 creates and stores block storage mapping table 408 in server storage 406.

At step 704, the system generates from the block storage mapping table a list of block identifiers that represent a list of data blocks. The list of data blocks, for instance, may represent a file divided into evenly sized data blocks for block storage. In an embodiment, a file 410 shown in FIG. 4 may be divided into fixed-sized data blocks of 512 bytes from which the rapid replication module 404 can generate a list of block identifiers from the block storage mapping table 408 that represent the list of data blocks. For example, the list of block identifiers, UUID14, UUID61, UUID11, UUID36, UUID47, UUID06 may be generated from the block storage mapping table 408 depicted in FIG. 6 that represent a list of 512-byte data blocks with the lower order 8 bits of 00001110, 00111101, 00001011, 00100100, 00101111, and 00000110.

At step 706, the system can store the list of block identifiers that represent the list of data blocks instead of the list data blocks. For example, the list of block identifiers, UUID14, UUID61, UUID11, UUID36, UUID47, UUID06 may be stored that represent the list of 512-byte data blocks with the lower order 8 bits of 00001110, 00111101, 00001011, 00100100, 00101111, and 00000110. In an embodiment, the rapid replication module 404 as shown in FIG. 4 can store the list of block identifiers that represent the list of data blocks.

At step 708, the system may update data blocks in the list of data blocks by updating the corresponding block identifiers in the list of block identifiers. Given an update of a list of 512-byte data blocks with the lower order 8 bits of 00001110, 00111101, 00001011, 00100100, 00101111, and 00000110 where the update replaces the 512-byte data block with the lower order 8 bits of 00001011 with the 512-byte data block with the lower order 8 bits of 10000020, resulting in a list of 512-byte data blocks with the lower order 8 bits of 00001110, 00111101, 10000020, 00100100, 00101111, and 00000110, the list of block identifiers, UUID14, UUID61, UUID11, UUID36, UUID47, UUID06 can be updated by replacing block identifier UUID11 with UUID130, resulting in an updated list of block identifiers, UUID14, UUID61, UUID130, UUID36, UUID47, UUID06. In an embodiment, the rapid replication module 404 as shown in FIG. 4 can update data blocks in the list of data blocks by updating the corresponding block identifiers in the list of block identifiers.

At step 710, the system replicates the list of data blocks in primary storage by storing the list of block identifiers in recovery storage. For example, the list of block identifiers, UUID14, UUID61, UUID11, UUID36, UUID47, UUID06 may be sent to and stored in recovery storage that represent the list of 512-byte data blocks with the lower order 8 bits of 00001110, 00111101, 00001011, 00100100, 00101111, and 00000110. In an embodiment, the rapid replication module 404 as shown in FIG. 4 can send the list of block identifiers that represent the list of data blocks to recovery storage. Those skilled in the art should appreciate the significant reduction in data transmission in the cloud by sending the list of block identifiers to recovery storage instead of the list of data blocks, especially for a large list of data blocks.

At step 712, the system restores the list of data blocks in primary storage from the list of block identifiers in recovery storage. For example, the list of block identifiers, UUID14, UUID61, UUID11, UUID36, UUID47, UUID06 that represent the list of data blocks from a file divided into data blocks for block storage may be retrieved from recovery storage when the file needs to be restored, and each block identifier may be used to obtain the block data from the block storage mapping table to construct the list of data blocks to restore the file. In an embodiment, the rapid replication module 404 as shown in FIG. 4 can restore the list of data blocks in primary storage from the list of block identifiers in recovery storage. A block identifier may be used to obtain the block data from the block storage mapping table 408 in FIG. 4 by calculating the exponent of the power of two that has the closest lower value to the appended decimal value of the block identifier, indexing the array element with the value of the exponent, traversing the linked list of nodes in that bucket of the array element to locate the node with the block identifier, and obtaining the block data assigned to that node with the block identifier.

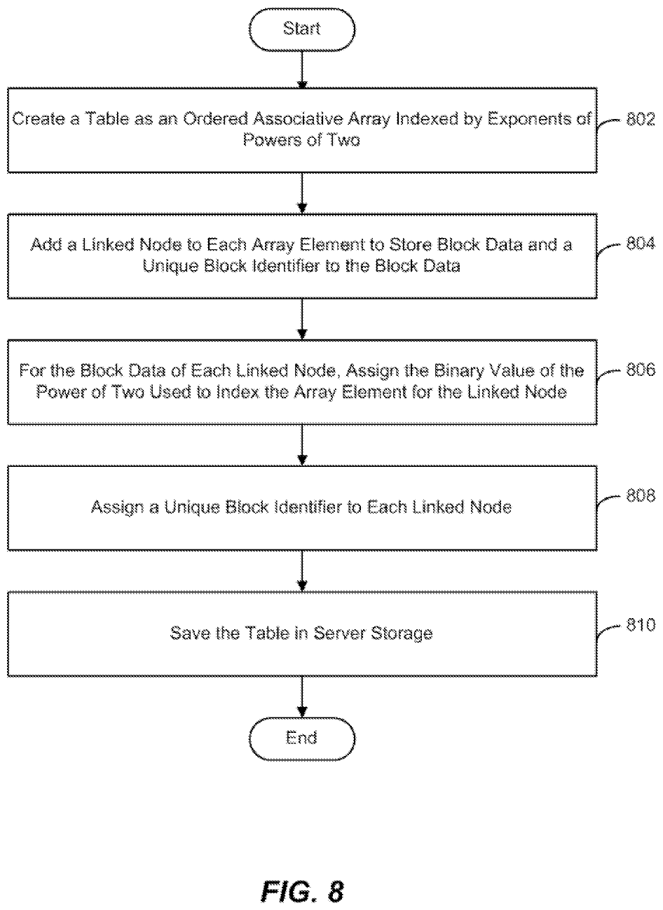

FIG. 8 shows a flowchart of an exemplary method in accordance with aspects of the present invention. Steps of the method may be carried out in the environment of FIG. 4 and are described with reference to elements depicted in FIG. 4 and in FIG. 5. In particular, the flowchart of FIG. 8 shows an exemplary method of creating the block storage mapping table 408 shown in FIG. 4 and FIG. 5.

At step 802, the system creates a table as an ordered associative array indexed by exponents of powers of two with a number of array element equivalent to the number of bits in a data block. In an embodiment, the associative array of elements can store integers from 0 to 4095 that represent 2ⁿ buckets where n is the number of bits in a fixed-sized data block of 512 bytes. In an embodiment, the rapid replication module 404 as shown in FIG. 4 creates the block storage mapping table 408 as an ordered associative array of elements 504 as shown in FIG. 5 that store integers from 0 to 4095 used to index the table by exponents of powers of two.

At step 804, the system adds a linked list node to each array element to store block data and a block identifier to the block data. Each of the linked list nodes associate a block identifier with block data belonging to that bucket for a given exponent of a power of two. In an embodiment, the rapid replication module 404 as shown in FIG. 4 adds a linked list node 506 to each array element 504 as shown in FIG. 5 to store block data and a block identifier to the block data.

At step 806, the system assigns the binary value of the power of two used to index the array element for the block data of each respective first linked node of each array element. For example, linked list node 504 is shown in FIG. 5 with block data 508 assigned the value of 00000001, the lower order 8 bits of 512 bytes of the binary value of 2⁰. Note that FIG. 5 only shows the lower order 8 bit values of a 512-byte data block for brevity of illustration. In an embodiment, the rapid replication module 404 as shown in FIG. 4 assigns the binary value of the power of two used to index the array element for the linked node for the block data of each linked node.

At step 808, the system assigns a unique block identifier to each linked node. For instance, the first linked list node for each bucket for a given exponent of a power of two has a block identifier assigned in the embodiment shown in FIG. 5 a value of a universally unique identifier (UUID) appended with the decimal value of the exponent of the power of two for indexing that bucket. For example, linked list node 504 is shown in FIG. 5 with block identifier 506 assigned the value UUID01. In an alternate embodiment, an initial UUID with a date and time stamp can be generated, such as 6 Jan. 2022 8.46.31 for example, and assigned the lowest binary value of 00000000. This UUID can be incremented by a microsecond for each subsequent UUID that is assigned to the next sequentially ordered block data of the binary combinations of 512 bytes. For example, the initial UUID with the date and time stamp, 6 Jan. 2022 8.46.31, can be incremented by 1 microsecond such as 6 Jan. 2022 8.46.32 and assigned as the block identifier to the initial linked list node 506 that is assigned the block data value of 00000001. Each subsequent UUID may be accordingly assigned so that block identifiers result in an assignment in ascending order by date and time stamp incremented by 1 microsecond in one-to-one correspondence to each block data of the binary combinations of 512 bytes arranged in ascending order by binary value. The rapid replication module 404 as shown in FIG. 4 assigns a unique block identifier to each linked node in an embodiment.

And at step 810, the system saves the table in server storage. After assigning a block identifier and block data for the first linked list node of each array element, the table is initialized and may be used to generate block identifiers for data blocks, update data blocks in a list of data blocks by updating corresponding block identifiers in a list of block identifiers, replicate a list of data blocks in primary storage as list of block identifiers in recovery storage, and restore a list of data blocks in primary storage from a list of block identifiers in recovery storage. In an embodiment, the rapid replication module 404 as shown in FIG. 4 saves the table in server storage.

Those skilled in the art will appreciate other data structures may be created in an embodiment for mapping block identifiers to binary combinations of block data and which can be used to generate block identifiers for data blocks using a permuto-combination method and universally unique identifiers (UUIDs). For example, a different data structure may be used to distribute block data evenly across lists of buckets, such as lists of linked nodes that maintain the one-to-one correspondence from lowest value to highest value of block identifiers assigned with values arranged in ascending sequential order to binary block data values arranged in ascending sequential order. Furthermore, other data structures may be created in an embodiment for mapping block identifiers to binary combinations of different fixed-size data blocks such as 128-byte data blocks, 256-byte data blocks and so forth.

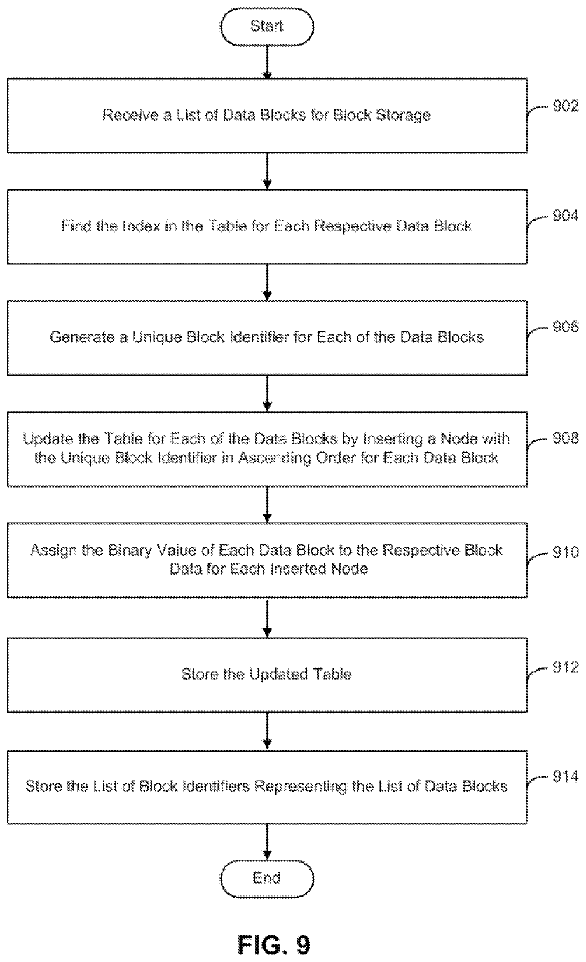

FIG. 9 shows a flowchart of an exemplary method in accordance with aspects of the present invention. Steps of the method may be carried out in the environment of FIG. 4 and are described with reference to elements depicted in FIGS. 4-6. In particular, the flowchart of FIG. 9 shows an exemplary method of generating block identifiers for data blocks using the block storage mapping table 408 shown in FIGS. 4-6.

At step 902, the system receives a list of data blocks for block storage. For instance, a list of 512-byte data blocks with these lower order 8 bit values 00001110, 00111101, 00001011, 00100100, 00101111, and 00000110 may represent a file 410 shown in FIG. 4 divided into fixed-sized data blocks of 512 bytes. In an embodiment, the rapid replication module 404 shown in FIG. 4 can receive the list of data blocks for block storage.

At step 904, the system finds an exponent of a power of two used to index the table for each data block. For example, the exponent of a power of two used to index the table for the first data block in the list, 00001110, can be found by calculating the exponent for the power of two that has the closest lower binary value (i.e. 8) than the binary value of the data block (i.e. 14), which is the exponent 3. In turn, the exponent of a power of two used to index the table for each of the remaining data blocks 00111101, 00001011, 00100100, 00101111, and 00000110 are similarly found by calculating the exponent for the power of two that has the closest lower binary value (i.e. 5, 3, 5, 5, and 2 respectively) to the binary value of the respective data blocks (i.e. 61, 11, 36, 47, and 6 respectively). In an embodiment, the rapid replication module 404 shown in FIG. 4 can find an exponent of a power of two used to index the table for each data block.

At step 906, the system generates a unique block identifier for each of the data blocks. The block identifier for a data block can be generated by indexing the table by the exponent of the power of two that has the closest lower binary value to the binary value of the data block and incrementing the block identifier value of the first node in the linked list of nodes in that bucket of the table by the difference of the values of the data block and the block data of the first node. For example, node 606 shown in FIG. 6 is assigned the block identifier of UUID14 by incrementing the block identifier value of the first node, UUID08, in the linked list of nodes in that bucket of the array element by the difference of the values of the data block (i.e. 14) and the first node (i.e. 8). In this way, the rapid replication module 404 shown in FIG. 4 can generate block identifiers from the block storage mapping table 408 for data blocks in an embodiment. And, accordingly, the block identifiers, UUID14 assigned to node 606, UUID61 assigned to node 612, UUID11 assigned to node 604, UUID36 assigned to node 608, UUID47 assigned to node 610, and UUID06 assigned to node 602, shown in FIG. 6 can be generated from the block storage mapping table 408 depicted in FIG. 5 for the 512-byte data blocks with the lower order 8 bits of 00001110, 00111101, 00001011, 00100100, 00101111, and 00000110.

At step 908, the system updates the table for each of the data blocks by inserting a node with the unique block identifier in ascending order in the linked list indexed by the exponent of the power of two for each respective data block. For example, the linked list node 606 shown in FIG. 6 is inserted with the block identifier of UUID14 by indexing the table with the value of 3, traversing the linked list of nodes in that bucket of the table, and inserting that node in the linked list of nodes in ascending order by value of the block identifiers. In an embodiment, the rapid replication module 404 shown in FIG. 4 updates the table for each of the data blocks by inserting a node with the unique block identifier in ascending order in the linked list indexed by the exponent of the power of two for each respective data block.

At step 910, the system assigns the binary value of each data block to the respective block data for each inserted node with the unique block identifier generated for each respective data block. For example, the linked list node 606 shown in FIG. 6 with the assigned block identifier of UUID14 for the data block with the lower order 8 bit binary value of 00001110 is assigned the binary value of 00001110. And the block data values for each inserted node with the block identifiers UUID61 assigned to node 612, UUID11 assigned to node 604, UUID36 assigned to node 608, UUID47 assigned to node 610, UUID06 assigned to node 602 are respectively assigned the binary values of 00111101, 00001011, 00100100, 00101111, and 00000110 as shown in FIG. 6. In an embodiment, the rapid replication module 404 shown in FIG. 4 assigns the binary value of each data block to the respective block data for each inserted node with the unique block identifier generated for each respective data block.

At step 912, the system stores the updated table. In an embodiment, the rapid replication module 404 as shown in FIG. 4 stores the updated table in server storage. In an alternative embodiment for generating block identifiers for data blocks, an initial UUID with a date and time stamp can be generated, such as 6 Jan. 2022 8.46.31 for example, and assigned the lowest binary value of 00000000. This UUID can be incremented by a microsecond for each subsequent UUID that is assigned to the next sequentially ordered block data of the binary combinations of 512 bytes. For example, the initial UUID with the date and time stamp, 6 Jan. 2022 8.46.31, can be incremented by 1 microsecond such as 6 Jan. 2022 8.46.32 and assigned as the block identifier to the initial linked list node 506 that is assigned the block data value of 00000001. Each subsequent UUID may be accordingly assigned so that block identifiers result in an assignment in ascending order by date and time stamp incremented by 1 microsecond in one-to-one correspondence to each block data of the binary combinations of 512 bytes arranged in ascending order by binary value.

At step 914, the system stores the list of block identifiers representing the list of data blocks instead of the list of data blocks. Such a list of block identifiers may be stored in recovery storage to replicate the list of data blocks in primary storage, and such a list of block identifiers stored in recovery storage may be used to restore the list of data blocks in primary storage. In an embodiment, the rapid replication module 404 shown in FIG. 4 stores the list of block identifiers representing the list of data blocks instead of the list of data blocks.

In an embodiment for generating block identifiers for data blocks, a multiplexer may be used to generate a UUID with a data and time stamp. In this embodiment, a data block may be input to the multiplexer with an initial UUID that has a date and time stamp, and the multiplexer can output a 64 bit UUID with a date and time stamp for that data block. The multiplexer can increment the time stamp by a microsecond for each subsequent UUID that is assigned to the next sequentially ordered block data of the binary combinations of 512 bytes arranged in ascending order.

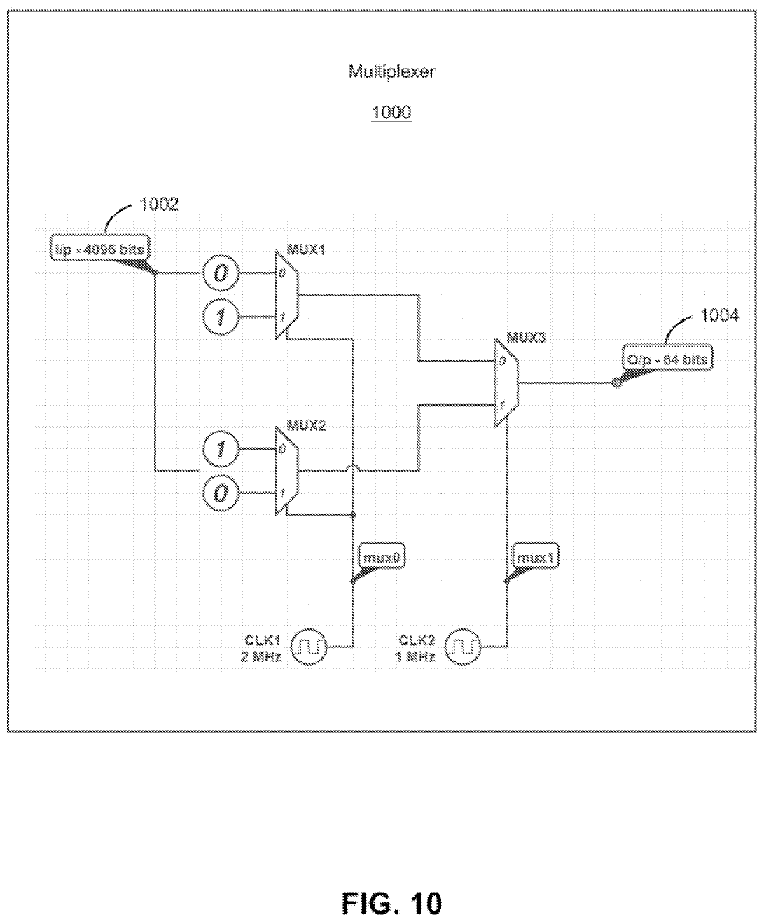

FIG. 10 depicts an exemplary circuit diagram of a multiplexer for generating unique block identifiers in accordance with aspects of the present invention. For example, FIG. 10 illustrates a circuit diagram of a digital multiplexer 1000 designed to receive an input of 4096 bits 1002, pass the input through MUX1, MUX2 and MUX3, and generate an output of 64 bits 1004. The multiplexer can be a microchip operably coupled to the exemplary environment of a computer system such as computer system 12 described with respect to FIG. 1. In an embodiment, a data block of 4096 bits that needs to be assigned a block identifier may be input to the multiplexer 1000 with an initial UUID date and time stamp, and the multiplexer will output a 64 bit UUID with date and time stamp for that data block. This UUID can be incremented by a microsecond for each subsequent UUID that is assigned to the next sequentially ordered block data of the binary combinations of 512 bytes. In this manner, each UUID may be accordingly assigned so that block identifiers result in an assignment in ascending order by date and time stamp incremented by 1 microsecond in one-to-one correspondence to each block data of the binary combinations of 512 bytes in ascending order by binary value. Thus the multiplexer may generate unique block identifiers for fixed-size data block of 512 bytes. In an embodiment with other fixed-size data blocks, for example, of 128 bytes or 256 bytes, a multiplexer can be used that receives 1024 bits or 2048 bits respectively as input to generate a 16 bit identifier.

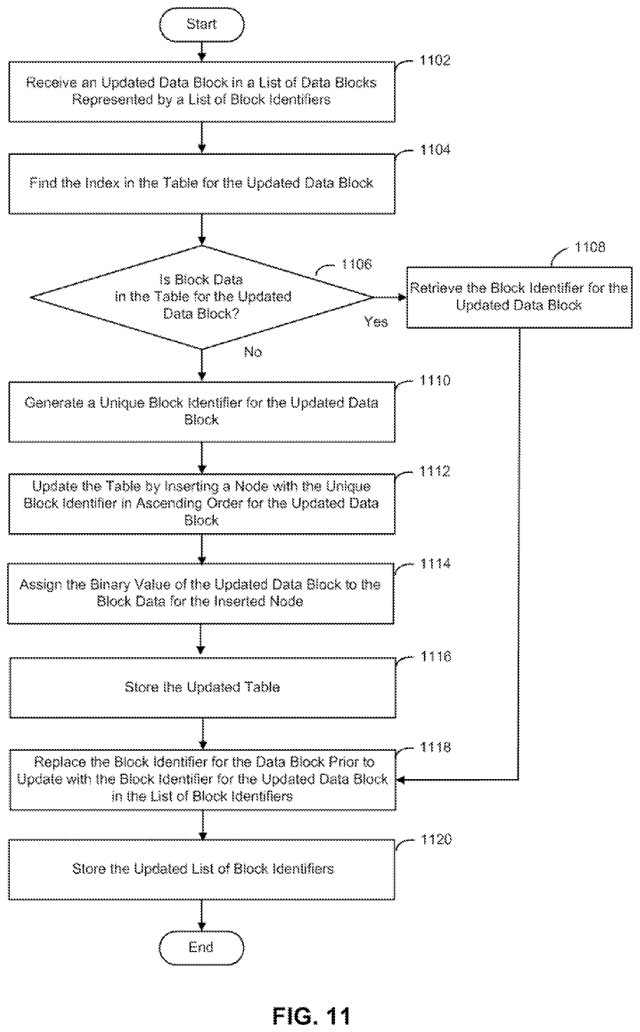

FIG. 11 shows a flowchart of an exemplary method in accordance with aspects of the present invention. Steps of the method may be carried out in the environment of FIG. 4 and are described with reference to elements depicted in FIGS. 4-6. In particular, the flowchart of FIG. 11 shows an exemplary method of updating data blocks in a list of data blocks by updating corresponding block identifiers in a list of block identifiers using the block storage mapping table 408 shown in FIGS. 4-6.

At step 1102, the system receives an updated data block in a list of data blocks represented by a list of block identifiers. For example, a data block with the lower order 8 bits of 10000020 may be received to replace a data block with the lower order 8 bits of 00001011 in a list of 512-byte data blocks with the lower order 8 bits of 00001110, 00111101, 00001011, 00100100, 00101111, and 00000110. In an embodiment, the rapid replication module 404 shown in FIG. 4 receives the updated data block in a list of data blocks represented by a list of block identifiers.

At step 1104, the system finds an exponent of a power of two used to index the table for the updated data block. For example, the exponent of a power of two used to index the table for the updated data block, 10000020, can be found by calculating the exponent for the power of two that has the closest lower binary value (i.e. 128) than the binary value of the data block (i.e. 130), which is the exponent 7. In an embodiment, the rapid replication module 404 shown in FIG. 4 finds an exponent of a power of two used to index the table for the updated data block.

At step 1106, the system determines whether the block data for the updated data block is in the linked list of nodes indexed by the exponent of the power of two. In an embodiment, the rapid replication module 404 shown in FIG. 4 traverses the linked list of nodes in the block mapping table 408 shown in FIG. 6 indexed by the exponent 7 to check if the block data is in the linked list of nodes. If the system determines that the block data for the updated data block is in the linked list of nodes, then the system continues carrying out steps of the exemplary method at step 1108. If not, then the system continues carrying out steps of the exemplary method at step 1110.

At step 1108, the system retrieves the block identifier from the node that has the block data for the updated data block, if the system determines at step 1106 that the block data for the updated data block is in the linked list of nodes. For example, if the lower order 8 bit block data for the updated data block were 00111101 instead of 10000020, then the rapid replication module 404 shown in FIG. 4 traverses the linked list of nodes in the block mapping table 408 shown in FIG. 6 indexed by the exponent 5 in an embodiment to check if the block data is in the linked list of nodes and finds the block data of 00111101 in node 612 as shown in FIG. 6. In this case, the system would retrieve the block identifier UUID61 assigned to node 612.

At step 1110, the system generates a unique block identifier for the updated data block, if the system determines at step 1106 that the block data for the updated data block is not in the linked list of nodes, as is the case for the data block of 10000020. The block identifier for a data block can be generated by indexing the table by the exponent of the power of two that has the closest lower binary value to the binary value of the data block and incrementing the block identifier value of the first node in the linked list of nodes in that bucket of the table by the difference of the values of the data block and the block data of the first node. Accordingly, the exponent of the power of two that has the closest lower binary value to the binary value of the updated data block of 10000020 is 7. And the block identifier of UUID130 is generated by indexing the table using the exponent 7 and incrementing the block identifier value of the first node, UUID128, in the linked list of nodes in that bucket of the array element by the difference of the values of the data block (i.e. 130) and the first node (i.e. 128). In an embodiment, the rapid replication module 404 shown in FIG. 4 can generate a block identifier from the block storage mapping table 408 for an updated data block. As noted above, in an alternative embodiment for generating block identifiers for data blocks, an initial UUID with a date and time stamp can be generated, such as 6 Jan. 2022 8.46.31 for example, and assigned the lowest binary value of 00000000, and this UUID can be incremented by a microsecond for each subsequent UUID that is assigned to the next sequentially ordered block data of the binary combinations of 512 bytes.

At step 1112, the system updates the table by inserting a node with the unique block identifier in ascending order in the linked list indexed by the exponent of the power of two for the updated data block. For example, a linked list node is inserted with the block identifier of UUID130 by indexing the table with the value of 7, traversing the linked list of nodes in that bucket of the table, and inserting that node in the linked list of nodes in ascending order by value of the block identifiers. In an embodiment, the rapid replication module 404 shown in FIG. 4 updates the table with the updated data block by inserting a node with the unique block identifier UUID130 in ascending order in the linked list indexed with the value of 7, the exponent of the power of two that has the closest lower binary value to the binary value of the updated data block of 10000020.

At step 1114, the system assigns the binary value of the updated data block to the block data for the inserted node with the unique block identifier generated for the updated data block. For example, the linked list node inserted in the table with the assigned block identifier of UUID for the data block with the lower order 8 bit binary value of 10000020 is assigned the binary value of 10000020. In an embodiment, the rapid replication module 404 shown in FIG. 4 assigns the binary value of 10000020 to the linked list node inserted in the table with the assigned block identifier of UUID130.

At step 1116, the system stores the updated table. In an embodiment, the rapid replication module 404 as shown in FIG. 4 stores the updated table in server storage.

At step 1118, the system replaces the block identifier for the data block prior to update with the block identifier for the updated data block in the list of block identifiers. Given the list of 512-byte data blocks with the lower order 8 bits of 00001110, 00111101, 00001011, 00100100, 00101111, and 00000110 and a data block with the lower order 8 bits of 10000020 to replace the data block with the lower order 8 bits of 00001011, the list of block identifiers, UUID14, UUID61, UUID11, UUID36, UUID47, UUID06 is update to UUID14, UUID61, UUID130, UUID36, UUID47, UUID06 by replacing the block identifier UUID11 with the block identifier UUID130. In an embodiment, the rapid replication module 404 as shown in FIG. 4 replaces the block identifier for the data block prior to update with the block identifier for the updated data block in the list of block identifiers.

At step 1120, the system stores the updated list of block identifiers. In an embodiment, the rapid replication module 404 shown in FIG. 4 stores the updated list of block identifiers. Such an updated list of block identifiers may be stored in an embodiment in recovery storage to replace the list of data blocks replicated from primary storage prior to updating the list of block identifiers. In an embodiment, the server can send the updated block identifier to the recovery server and the recovery server can update the list of block identifiers by replacing the corresponding block identifier.

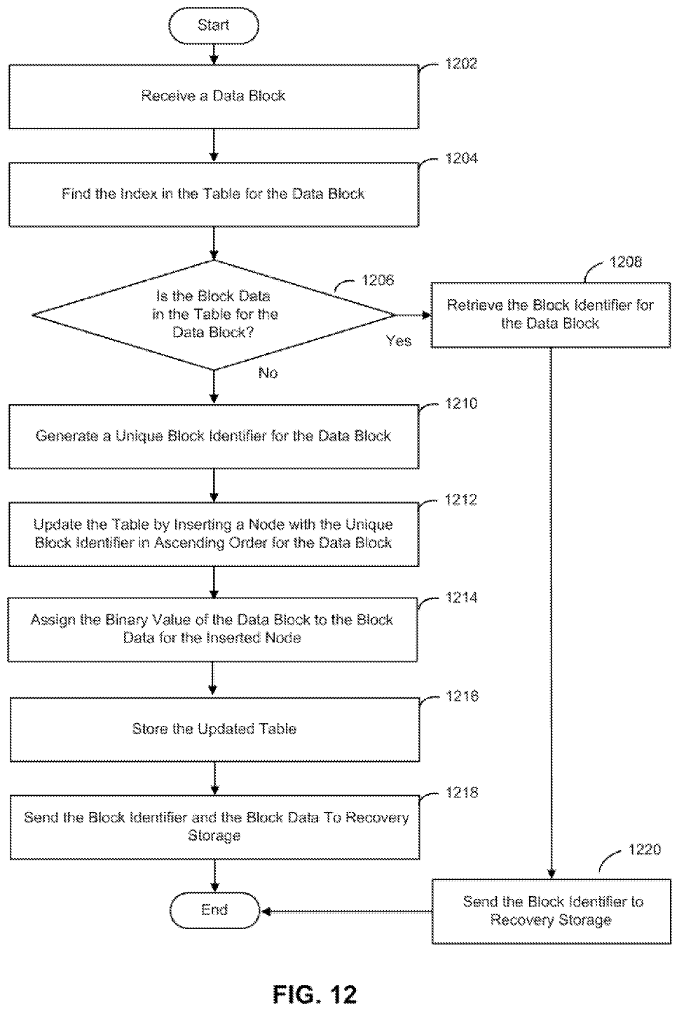

FIG. 12 shows a flowchart of an exemplary method in accordance with aspects of the present invention. Steps of the method may be carried out in the environment of FIG. 4 and are described with reference to elements depicted in FIG. 4 and FIG. 6. In particular, the flowchart of FIG. 12 shows an exemplary method of replicating a list of data blocks in primary storage by storing the list of block identifiers in recovery storage using the block storage mapping table 408 shown in FIG. 4 and FIG. 6.

At step 1202, the system receives a data block from a list of data blocks for replication. For example, a data block with the lower order 8 bits of 00001011 in a list of 512-byte data blocks may be received for replication. In an embodiment, the rapid replication module 404 shown in FIG. 4 receives the data block from a list of data blocks for replication.

At step 1204, the system finds an exponent of a power of two used to index the table for the data block. For example, the exponent of a power of two used to index the table for the data block, 00001011, can be found by calculating the exponent for the power of two that has the closest lower binary value (i.e. 8) to the binary value of the data block (i.e. 11), which is the exponent 3. In an embodiment, the rapid replication module 404 shown in FIG. 4 finds an exponent of a power of two used to index the table for the data block.

At step 1206, the system determines whether the block data for the data block is in the linked list of nodes indexed by the exponent of the power of two for the data block. In an embodiment, the rapid replication module 404 shown in FIG. 4 traverses the linked list of nodes in the block mapping table 408 shown in FIG. 6 indexed by the exponent 3 to check if the block data of 00001011 is in the linked list of nodes. If the system determines that the block data for the data block is in the linked list of nodes, then the system continues carrying out steps of the exemplary method at step 1208. If not, then the system continues carrying out steps of the exemplary method at step 1210.

At step 1208, the system retrieves the block identifier from the node that has the block data for the data block, if the system determines at step 1206 that the block data for the data block is in the linked list of nodes. For example, given the lower order 8 bit block data of 00001011, the rapid replication module 404 shown in FIG. 4 traverses the linked list of nodes in the block mapping table 408 shown in FIG. 6 indexed by the exponent 3 in an embodiment to check if the block data is in the linked list of nodes and finds the block data of 00001011 in node 604 as shown in FIG. 6. And the system retrieves the block identifier UUID11 assigned to node 604.

At step 1210, the system generates a unique block identifier for the data block, if the system determines at step 1206 that the block data for the data block is not in the linked list of nodes. The block identifier for a data block can be generated by indexing the table by the exponent of the power of two that has the closest lower binary value to the binary value of the data block and incrementing the block identifier value of the first node in the linked list of nodes in that bucket of the table by the difference of the values of the data block and the block data of the first node. In an embodiment, the rapid replication module 404 shown in FIG. 4 can generate a block identifier from the block storage mapping table 408 for the data block. As noted above, in an alternative embodiment for generating block identifiers for data blocks, an initial UUID with a date and time stamp can be generated, such as 6 Jan. 2022 8.46.31 for example, and assigned the lowest binary value of 00000000, and this UUID can be incremented by a microsecond for each subsequent UUID that is assigned to the next sequentially ordered block data of the binary combinations of 512 bytes.

At step 1212, the system updates the table by inserting a node with the unique block identifier in ascending order in the linked list indexed by the exponent of the power of two for the data block. For example, the linked list node 604 shown in FIG. 6 with the block identifier of UUID11 was inserted in the table by indexing the table with the value of 3, traversing the linked list of nodes in that bucket of the table, and inserting that node in the linked list of nodes in ascending order by value of the block identifiers. In an embodiment, the rapid replication module 404 shown in FIG. 4 updates the table by inserting a node with the unique block identifier in ascending order in the linked list indexed by the exponent of the power of two for the data block.

At step 1214, the system assigns the binary value of the data block to the block data for the inserted node with the unique block identifier generated for the data block. For example, the linked list node in the table with the assigned block identifier of UUID11 for the data block with the lower order 8 bit binary value of 00001011 was assigned the binary value of 00001011. In an embodiment, the rapid replication module 404 shown in FIG. 4 assigns the binary value of the data block to the block data for the inserted node with the unique block identifier generated for the data block.

At step 1216, the system stores the updated table. In an embodiment, the rapid replication module 404 as shown in FIG. 4 stores the updated table in server storage.

At step 1218, the system sends the block identifier and the block data to recovery storage for replication, if the system determines at step 1206 that the block data for the data block is not in the linked list of nodes. By doing so, the recovery storage may store the block identifier in a list of block identifiers for replication of a list of data blocks and may also store the block data in a block mapping storage table stored in recovery storage in an embodiment. In an embodiment, the rapid replication module 404 as shown in FIG. 4 sends the block identifier to recovery storage to store the block identifier in a list of block identifiers for replication of a list of data blocks and the block data to store in a block mapping storage table stored in recovery storage.

At step 1220, the system sends the block identifier to recovery storage for replication without the block data, if the system determines at step 1206 that the block data for the data block is in the linked list of nodes. In this case, the block data was previously sent to recovery storage. And the recovery storage may store the block identifier in a list of block identifiers for replication of a list of data blocks. In an embodiment, the rapid replication module 404 as shown in FIG. 4 sends the block identifier to recovery storage to store the block identifier in a list of block identifiers for replication of a list of data blocks.

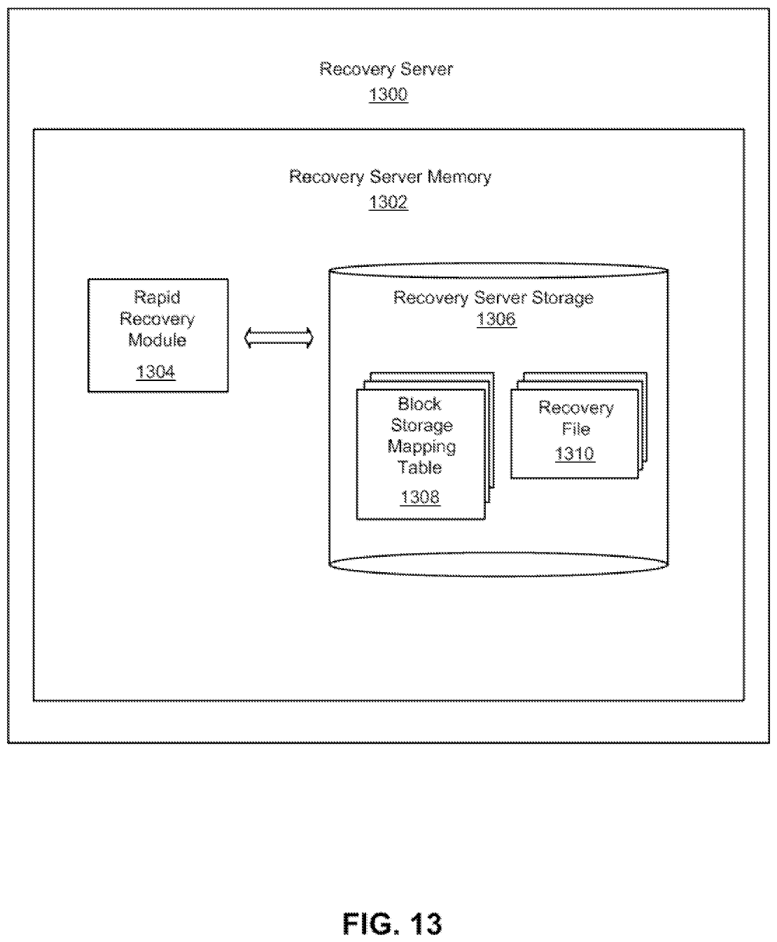

FIG. 13 shows a block diagram of an exemplary environment in accordance with aspects of the invention. In embodiments, the environment includes a recovery server 1300, which may be a computer system such as computer system 12 described with respect to FIG. 1, and a recovery server memory 1302 such as memory 28 described with respect to FIG. 1. In general, the recovery server 1300 provides services required for data storage and data recovery for replicated data. The recovery server 1300 includes, in recovery server memory 1302, a rapid recovery module 1304 having functionality in an embodiment to create a block mapping table that associates block identifiers with binary combinations of data, receives a list of block identifiers in primary storage, updates a block mapping table in recovery storage, stores the list of block identifiers in recovery storage, and sends the list of block identifiers to primary storage to restore a list of data blocks in primary storage. The rapid recovery module 1304 may also have functionality in an embodiment to receive updated block identifiers for replicated data blocks that are updated and replace the block identifiers for those replicated data blocks prior to update with the updated block identifiers in a list of block identifiers in recovery storage that represent the replication of the list of data blocks. The rapid recovery module 1304 may also have functionality in an embodiment to send the list of data blocks with the list of block identifiers in recovery storage to primary storage to restore a list of data blocks in primary storage.

In embodiments, the rapid recovery module 1304 may comprise one or more program modules such as program modules 42 described with respect to FIG. 1. The recovery server 1300 may include additional or fewer modules than those shown in FIG. 13. In embodiments, separate modules may be integrated into a single module. Additionally, or alternatively, a single module may be implemented as multiple modules. Moreover, the quantity of devices and/or networks in the environment is not limited to what is shown in FIG. 13. In practice, the environment may include additional devices and/or networks; fewer devices and/or networks; different devices and/or networks; or differently arranged devices and/or networks than illustrated in FIG. 13.

In accordance with aspects of the invention, the recovery server 1300 also includes, in recovery server memory 1302, recovery server storage 1306 which may be computer storage such as system storage 34 described with respect to FIG. 1. In embodiments, the recovery server storage 1306 stores information for mapping block identifiers with block data in a block storage mapping table 1308, and stores recovery files 1310 that may each have a list of block identifiers representing the replication of a list of evenly sized data blocks for block storage. For fixed-sized data blocks of 512 bytes, the block storage mapping table 1308 may store the association of block identifiers with data blocks representing binary combinations of 4096 bits. Those skilled in the art should appreciate that other fixed-sized data block may be used in embodiments such as 128 byte data blocks, 256 byte data blocks and so forth.

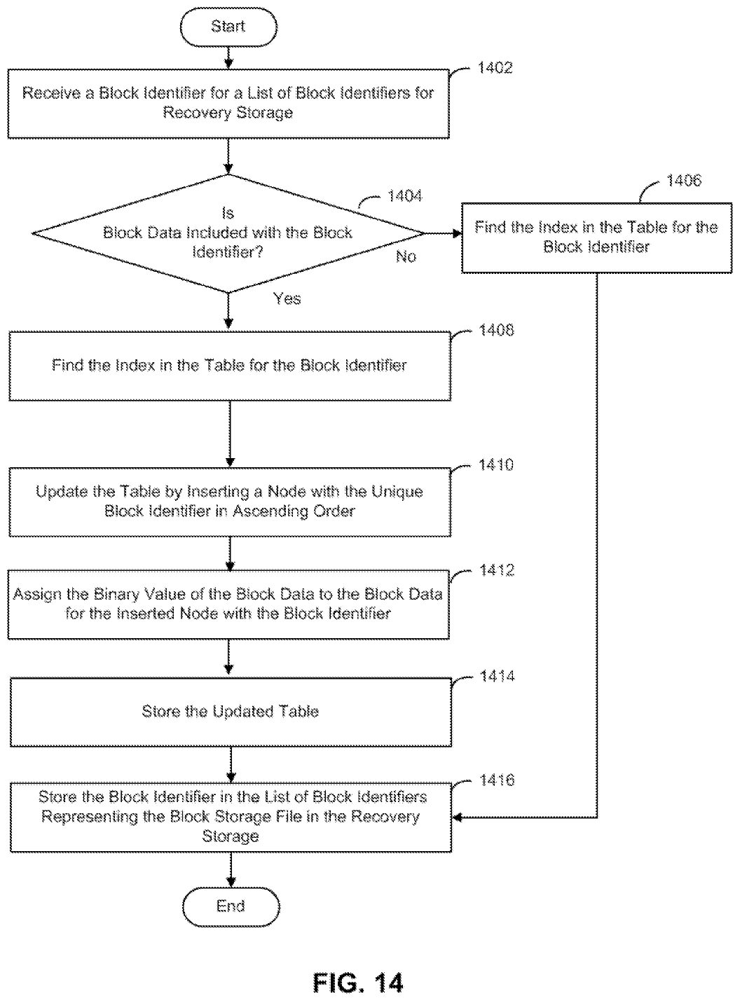

FIG. 14 shows a flowchart of an exemplary method in accordance with aspects of the present invention. Steps of the method may be carried out in the environment of FIG. 13 and are described with reference to elements depicted in FIG. 13. In particular, the flowchart of FIG. 14 shows an exemplary method of receiving a block identifier replicating a data block in primary storage and storing a block identifier in a list of block identifiers in recovery storage using a block storage mapping table.

At step 1402, the system receives a block identifier for a list of block identifiers for recovery storage that replicate a list of data blocks in a primary storage. For example, a block identifier of UUID 11 may be received in an embodiment. In an embodiment, the rapid recovery module 1304 shown in FIG. 13 receives the block identifier for a list of block identifiers for recovery storage that replicate a list of data blocks in a primary storage.

At step 1404, the system determines whether block data is also included with the block identifier. In an embodiment, the rapid recovery module 1304 shown in FIG. 13 determines whether block data is also included with the block identifier. If block data is included with the block identifier, then the block data has not been sent previously from primary storage and the block storage mapping table in recovery storage can be updated with the block data received. If the system determines that the block data is included with the block identifier, then the system continues carrying out steps of the exemplary method at step 1408. If not, then the system continues carrying out steps of the exemplary method at step 1406.

At step 1406, the system finds an exponent of a power of two used to index the table for the block identifier, if the system determines that the block data is not included with the block identifier at step 1404. In this case, the block data has been previously sent from primary storage and the block data is already stored the block storage mapping table in an embodiment. To do so, the exponent of a power of two used to index the table for the block identifier, UUID11, can be found for example by calculating the exponent for the power of two that has the closest lower value (i.e. 8) to the appended decimal value of the block identifier (i.e. 11), which is the exponent 3. In an embodiment, the rapid recovery module 1304 shown in FIG. 13 finds an exponent of a power of two used to index the table for the block identifier. The system continues carrying out steps of the exemplary method at step 1416 to store the block identifier in the list of block identifiers representing the block storage file in recovery storage.

At step 1408, the system finds an exponent of a power of two used to index the table for the block identifier, if the system determines that the block data is included with the block identifier at step 1404. In this case, the block data has not been sent previously from primary storage and the block storage mapping table may be updated with the block data received in an embodiment. To do so, the exponent of a power of two used to index the table for the block identifier, UUID11, can be found for example by calculating the exponent for the power of two that has the closest lower value (i.e. 8) to the appended decimal value of the block identifier (i.e. 11), which is the exponent 3. In an embodiment, the rapid recovery module 1304 shown in FIG. 13 finds an exponent of a power of two used to index the table for the block identifier.

At step 1410, the system updates the table by inserting a node with the block identifier in ascending order in the linked list indexed by the power of two for the block identifier. For example, a linked list node with the block identifier of UUID11 can be inserted in the table by indexing the table with the value of 3, traversing the linked list of nodes in that bucket of the table, and inserting that node in the linked list of nodes in ascending order by value of the block identifiers. In an embodiment, the rapid recovery module 1304 shown in FIG. 13 updates the table by inserting a node with the block identifier in ascending order in the linked list indexed by the exponent of the power of two for the block identifier.

At step 1412, the system assigns the binary value of the block data included with the block identifier to the block data for the inserted node with the block identifier. For example, the binary value of 00001011 is assigned to the block data of the linked list node inserted in the table with the assigned block identifier of UUID 11. In an embodiment, the rapid recovery module 1304 shown in FIG. 13 assigns the binary value of the data block included with the block identifier to the block data for the inserted node with the block identifier.

At step 1414, the system stores the updated table in recovery storage. In an embodiment, the rapid recovery module 1304 shown in FIG. 13 stores the updated block storage mapping table 1308 in recovery server storage 1306.

At step 1416, the system stores the block identifier in the list of block identifiers representing the block storage file in recovery storage. In an embodiment, the rapid recovery module 1304 shown in FIG. 13 stores the block identifier in the list of block identifiers in a recovery file 1310 the block storage file in recovery server storage 1306. Such a list of block identifiers are then stored in recovery storage to replicate the list of data blocks in primary storage, and such a list of block identifiers stored in recovery storage may be used to restore the list of data blocks in primary storage.

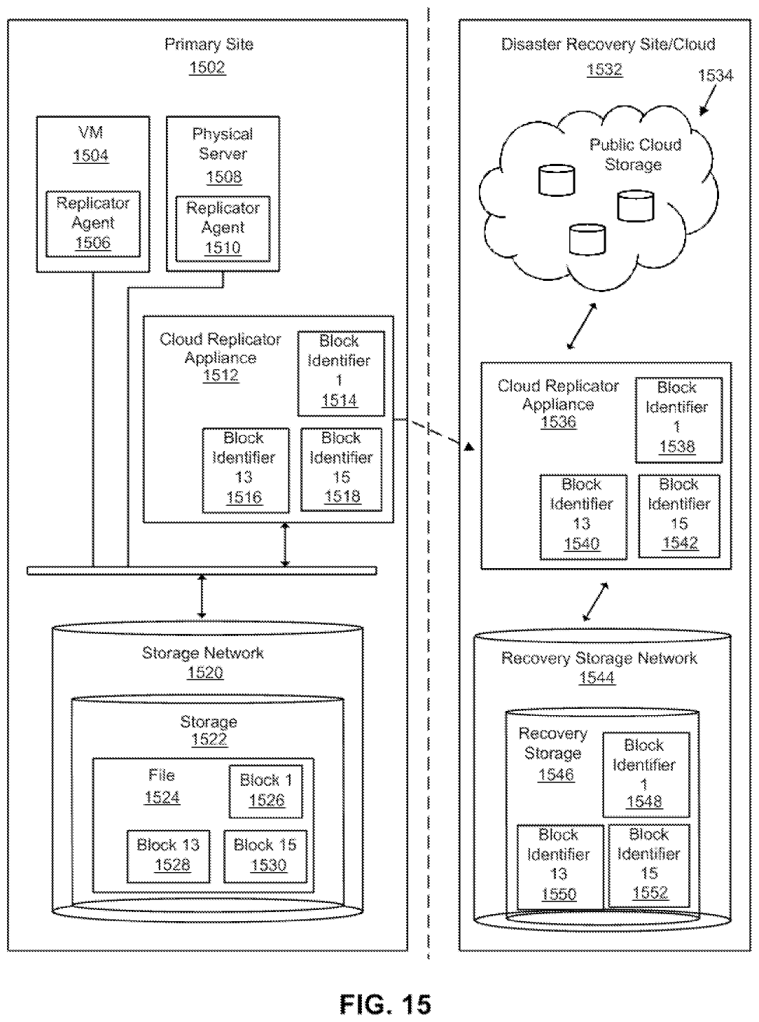

FIG. 15 depicts an exemplary architecture in an exemplary cloud computing environment in accordance with aspects of the invention. In embodiments, the exemplary architecture includes a primary site 1502 that sends block identifiers 1514, 1516 and 1518 to a disaster recovery site 1532 that may store those block identifiers in recovery storage 1546 as block identifiers 1548, 1550, and 1552, or in public cloud storage 1534, or in a combination of both. The primary site can include, for example, a virtual machine (VM) 1504 that employs a replicator agent 1506, a physical server 1508 that employs a replicator agent 1510, a cloud replicator appliance 1512, and a storage network 1520. The VM 1504, the physical server 1508, the cloud replicator appliance 1512, and the storage network 1520 are cloud computing nodes that may communicate with one another and are grouped physically or virtually, in one or more networks, such as Private, Community, Public, or Hybrid clouds, such as cloud computing node 10 described with respect to FIG. 1 and FIG. 2. The replicator agents 1506 and 1510 have functionality in an embodiment for providing services for replicating data files and recovering data files between the cloud computing nodes, VM 1504 and the physical server 1508, and the cloud 1534 and/or recovery storage 1546. The replicator agents 1506 and 1510 may comprise one or more program modules such as program modules 42 described with respect to FIG. 1. The VM 1504 and the physical server 1508 may include additional or fewer modules than those shown in FIG. 15. In embodiments, separate modules may be integrated into a single module. Additionally, or alternatively, a single module may be implemented as multiple modules.

The cloud replicator appliance 1512 may be a computer system such as server 400 described with respect to FIG. 4 that has functionality to provide services required for data storage, data replication, and data recovery. For instance, the cloud replicator appliance 1512 can include the rapid replication module 404 (not shown) described with respect to FIG. 4 having functionality to create a block mapping table that associates block identifiers with binary combinations of data, receive a list of data blocks in primary storage, generate a list of block identifiers from the list of data block using the block mapping table, and send the list of block identifiers to a backup storage for replication of the list of data blocks. The cloud replicator appliance 1512 may also include the functionality of the rapid replication module 404 to update block identifiers for replicated data blocks that are updated, for instance, block identifiers 1514, 1516, and 1518 and send the updated block identifiers to backup storage to replace the block identifiers for those replicated data blocks. The cloud replicator appliance 1512 may further include the functionality of the rapid replication module 404 to restore a list of data blocks in primary storage by retrieving the list of block identifiers from backup storage and automatically generating the data blocks from the block mapping table for each of the block identifiers. The cloud replicator appliance 1512 may additionally include an operably coupled multiplexer (not shown) such as described with respect to FIG. 10 to generate a block identifier from a data block.

The storage network 1520 communicates with storage 1522 that stores file 1524 that include data blocks 1526, 1528 and 1530. The storage network 1520 may be a network of storage devices such as storage devices 65 shown in FIG. 3. In an embodiment, the storage network 1520 may provide block storage, for instance, in a Storage Area Network (SAN) or a cloud-based storage environment.

In an embodiment, the exemplary architecture of FIG. 15 also includes a disaster recovery site 1532 that may store block identifiers in recovery storage 1546 such as block identifiers 1548, 1550, and 1552, or in public cloud storage 1534, or in a combination of both. The disaster recovery (DR) site can include, for example, a cloud replicator appliance 1536 that communicates with a recovery storage network 1544 and the public cloud storage 1534. The cloud replicator appliance 1536 and recovery storage network 1544 are cloud computing nodes that may communicate with one another and are grouped physically or virtually, in one or more networks, such as Private, Community, Public, or Hybrid clouds, such as cloud computing node 10 described with respect to FIG. 1 and FIG. 2.

The cloud replicator appliance 1536 may be a computer system such as server 1300 described with respect to FIG. 13 that has functionality to provide services required for data storage, data replication, and data recovery. For instance, the cloud replicator appliance 1536 can include the rapid recovery module 1304 (not shown) described with respect to FIG. 13 having functionality in an embodiment to create a block mapping table that associates block identifiers with binary combinations of data, receives a list of block identifiers in primary storage, updates a block mapping table in recovery storage, stores the list of block identifiers in recovery storage, and sends the list of block identifiers to primary storage to restore a list of data blocks in primary storage. The cloud replicator appliance 1536 may also include the functionality of the rapid recovery module 1304 in an embodiment to receive updated block identifiers for replicated data blocks that are updated and replace the block identifiers for those replicated data blocks prior to update with the updated block identifiers in a list of block identifiers in recovery storage that represent the replication of the list of data blocks. The cloud replicator appliance 1536 may also include the functionality of the rapid recovery module 1304 in an embodiment to send a list of block identifiers in recovery storage to primary storage to restore a list of data blocks in primary storage. The cloud replicator appliance 1536 may additionally include an operably coupled multiplexer (not shown) such as described with respect to FIG. 10 to generate a block identifier from a data block.

The recovery storage network 1544 communicates with recovery storage 1546 that stores block identifiers 1548, 1550 and 1552. The recovery storage network 1544 may be a network of storage devices such as storage devices 65 shown in FIG. 3. In an embodiment, the recovery storage network 1544 may provide block storage, for instance, in a Storage Area Network (SAN) or a cloud-based storage environment. The quantity of devices and/or networks in the architecture is not limited to what is shown in FIG. 15. In practice, the environment may include additional devices and/or networks; fewer devices and/or networks; different devices and/or networks; or differently arranged devices and/or networks than illustrated in FIG. 15.

Each VM 1504 or physical machine 1508 in the primary site 1502 can have a replicator agent, 1506 and 1510 respectively, which stores changed blocks of file in storage in the primary site 1502 and sends the changed blocks of the file to the cloud replicator appliance 1512 in the primary site 1502. The cloud replicator appliance 1512 can find the block identifiers of the changed data blocks and send the block identifiers for changed blocks to the cloud replicator appliance 1536 in the DR site 1532. The cloud replicator appliance 1536 in the DR site 1532 can receive the changed block identifiers and store them in the list of block identifies in cloud storage.

For instance updating data blocks of a file, such as data blocks 1526, 1528 and 1530 of file 1524, shown in the exemplary architecture shown in FIG. 15 can be performed by following the exemplary method described in respect with FIG. 11, namely updating data blocks in a list of data blocks by updating corresponding block identifiers in a list of block identifiers using a block storage mapping table. Thus the cloud replicator appliance 1512 can receive an updated data block, such as each data block 1514, 1516 and 1518, and find the block data for the updated data block is in the linked list of nodes or update and save the table with a generated block identifier associated with the updated data block. The cloud replicator appliance 1512 can retrieve the block identifier for the updated data block, and replace the block identifier for the data block prior to update with the block identifier for the updated data block in a list of block identifiers representing the list of data blocks of file 1524. The cloud replicator appliance 1512 can send the updated block identifier or an updated list of block identifiers to the DR site 1532 and, for instance, the cloud replicator appliance 1536 on the DR site 1532 can receive the updated block identifier or the updated list of block identifiers to update the list of block identifiers by replacing the block identifier corresponding to the updated block identifier with the updated block identifier.

And cloud replicator appliance 1536 on the DR site 1532 can receive the updated block identifier for the updated data block, such as of each of block identifiers 1538, 1540, and 1542, or an updated list of block identifiers and find the block identifier for the updated data block in the linked list of nodes or update and save the table with a generated block identifier associated with the updated data block. The cloud replicator appliance 1536 can replace the block identifier for the data block prior to update with the block identifier for the updated data block in the list of block identifiers, such as block identifiers 1548, 1550, and 1552 in recovery storage 1546.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
creating, by a computing device, a mapping that associates a plurality of block identifiers with a plurality of binary combinations of data for a block size;
generating, from the mapping that associates the plurality of block identifiers with the plurality of binary combinations of data for the block size, by the computing device, a list of block identifiers representing a list of data blocks in a storage;
sending, by the computing device, the list of block identifiers to a backup storage in a cloud-based storage environment to replicate the list of data blocks in the storage; and
storing on a computer readable storage media the mapping that associates the plurality of block identifiers with the plurality of binary combinations of data for the block size and the list of block identifiers in the storage.

2. The method of claim 1, further comprising receiving, by the computing device, the list of data blocks in the storage.

3. The method of claim 1, further comprising receiving, by the computing device, the list of block identifiers sent by the backup storage to restore the list of data blocks in the storage from the mapping that associates the plurality of block identifiers with the plurality of binary combinations of data for the block size.

4. The method of claim 1, further comprising:
receiving, by the computing device, an updated data block for a data block in the list of data blocks in the storage;
retrieving, by the computing device, a block identifier for the updated data block from the mapping that associates the plurality of block identifiers with the plurality of binary combinations of data for the block size; and
replacing, by the computing device, the block identifier for the data block with the block identifier for the updated data block in the list of block identifiers.

5. The method of claim 4, further comprising sending, by the computing device, the block identifier for the updated data block to the backup storage.

6. The method of claim 4, further comprising updating the mapping that associates the plurality of block identifiers with the plurality of binary combinations of data for the block size with a mapping of the block identifier for the updated data block to the updated data block.

7. The method of claim 1, further comprising ordering, by the computing device, the mapping that associates the plurality of block identifiers with the plurality of binary combinations of data for the block size by a plurality of exponents of powers of two for the number of bits in the block size.

8. The method of claim 1, further comprising generating, by the computing device, a plurality of universally unique identifiers as the plurality of block identifiers in ascending order from an initial date and time stamp incremented by a predetermined time period for each of the plurality of universally unique identifier.

9. The method of claim 1, further comprising assigning sequentially from smallest to largest each of the plurality of block identifiers with each of the plurality of binary combinations of data arranged from the smallest to the largest.

10. The method of claim 1, further comprising updating the mapping that associates the plurality of block identifiers with the plurality of binary combinations of data for the block size with a mapping that associates each of the block identifiers in the list of block identifiers to each of the data blocks in the list of data blocks.

11. The method of claim 1, further comprising sending at least one data block in the list of block identifiers to the backup storage.

12. A computer program product comprising one or more computer readable storage media having program instructions collectively stored on the one or more computer readable storage media, the program instructions executable to:
receive, by a computing device, a block identifier for replication of a data block;
identify, by the computing device, the block identifier in a mapping that associates a plurality of block identifiers with a plurality of binary combinations of data for a block size; and
store on a computer readable storage media, by the computing device, the block identifier in a list of block identifiers for replication of a list of data blocks.

13. The computer program product of claim 12, wherein the executable instructions are further executable to receive, by the computing device, the block data associated with the block identifier for backup of the data block.

14. The computer program product of claim 13, wherein the executable instructions are further executable to update, by the computing device, the mapping that associates the plurality of block identifiers with the plurality of binary combinations of data for the block size with a mapping that associates the block identifier to the block data.

15. The computer program product of claim 12, wherein the executable instructions are further executable to send, by the computing device, the list of block identifiers to restore the list of data blocks in a primary storage.

16. A system comprising:
a processor, a computer readable memory, one or more computer readable storage media, and program instructions collectively stored on the one or more computer readable storage media, the program instructions executable to:
create, by the processor, a mapping that associates a plurality of block identifiers with a plurality of binary combinations of data for a block size;
generate from the mapping that associates the plurality of block identifiers with the plurality of binary combinations of data for the block size, by the processor, a list of block identifiers representing a list of data blocks in a storage;
send, by the processor, the list of block identifiers to a backup storage in a cloud-based storage environment to replicate the list of data blocks in the storage; and
store on a computer readable storage media the mapping that associates the plurality of block identifiers with the plurality of binary combinations of data for the block size and the list of block identifiers in the storage.

17. The system of claim 16, the program instructions further executable to:
receive, by the processor, an updated data block for a data block in the list of data blocks in the storage;
retrieve, by the processor, a block identifier for the updated data block from the mapping that associates the plurality of block identifiers with the plurality of binary combinations of data for the block size;
replace, by the processor, the block identifier for the data block with the block identifier for the updated data block in the list of block identifiers; and
send, by the processor, the block identifier for the updated data block to the backup storage.

18. The system of claim 16, the program instructions further executable to receive the list of block identifiers sent by the backup storage to restore the list of data blocks in the storage from the mapping that associates the plurality of block identifiers with the plurality of binary combinations of data for the block size.

19. The system of claim 16, the program instructions further executable to update the mapping that associates the plurality of block identifiers with the plurality of binary combinations of data for the block size with a mapping that associates each of the block identifiers in the list of block identifiers to each of the data blocks in the list of data blocks.

20. The system of claim 16, the program instructions further executable to send at least one data block in the list of block identifiers to the backup storage.
